(19) United States
(12) Patent Application Publication
(10) Pub. No.: US 2012/0192487 A1
(43) Pub. Date: Aug. 2, 2012

(54) NUTRICULTURE SYSTEM AND WATER TREATMENT APPARATUS FOR STERILIZATION AND PURIFICATION PURPOSES

(76) Inventors: Toshiharu Tanaka, Nagano (JP); Katsuhisa Yata, Nagano (JP)

(21) Appl. No.: 13/499,794

(22) PCT Filed: Oct. 5, 2010
(86) PCT No.: PCT/JP2010/067433

§ 371 Date: Apr. 2, 2012

(30) Foreign Application Priority Data
Oct. 5, 2009 (JP) 2009-231606

(51) Int. Cl. A01G 31/02; C02F 1/78; C02F 1/32

(52) U.S. Cl. 47/60; 47/62 R; 422/186.3

(57) ABSTRACT

A nutriculture system enables the circulation of a nutrient solution while preventing the proliferation of pathogenic bacteria and can promote the growth of plants effectively and steadily while preventing the change in components of the nutrient solution. A water treatment apparatus for sterilization and purification purposes is compact in size. Specifically, the nutriculture system can circulate a culture solution, which is a liquid fertilizer, between a nutrient solution tank and a culture bed. The water treatment apparatus is disposed between the nutrient solution tank and the culture bed, sterilizes and purifies only the culture solution that flows through the culture bed and includes a unit having an ozone supply function for supplying ozone to the culture solution, an ultraviolet ray irradiation function for irradiating the culture solution with ultraviolet rays, and a photocatalyst-acting function for allowing a photocatalyst to act.

### TECHNICAL FIELD

The present invention relates to a nutriculture system for subjecting plants to nutriculture and to a water treatment apparatus and, particularly to a nutriculture system suitable for hydroponic culture and a water treatment apparatus for sterilization and purification purposes.

### BACKGROUND ART

As the nutriculture system of this type, a nutrient solution circulation system 1 shown in FIG. 14 has conventionally been proposed. The nutrient solution circulation system 1 is equipped with a nutrient solution reservoir 2 and culture beds 3 for culturing plants. To the nutrient solution reservoir 2, a makeup water line 4 and nutrient solution supply lines 7 of accumulation tanks 6 having an appropriate amount of an undiluted nutrient solution are connected. The nutrient solution reservoir 2 and culture beds 3 are connected to each other with supply lines 8 and return lines 9. In the nutrient solution circulation system 1, a nutrient solution 10 in the nutrient solution reservoir 2 is supplied to the culture beds 3 via the supply lines 8 and accumulated in the nutrient solution reservoir 2 via the return lines 9.

A nutrient solution circulation system 11 of FIG. 15 is a combination of the nutrient solution circulation system of FIG. 14 with a purification apparatus 12, in which a nutrient solution reservoir 2 and culture beds 3 are connected to each other with supply lines 8 and return lines 9, and the purification apparatus 12 is connected to the nutrient solution reservoir 2. In nutrient solution circulation system 11, a nutrient solution 10 in the nutrient solution reservoir 2 is supplied to the culture beds 3 via supply lines 8 and accumulated in the nutrient solution reservoir 2 via return lines 9. The purification apparatus 12 is adapted to purify an entire nutrient solution 10 in the nutrient solution reservoir 2.

In a nutriculture apparatus used in a nutriculture method disclosed in Patent Document 1, a drainage tank is connected to culture beds, and a sterilization apparatus is connected to the drainage tank. The sterilization apparatus is provided therein with a hollow fiber membrane module with which bacteria and impurities in the drainage tank are removed. On the other hand, a raw water flow passage is connected to the culture beds via an ozone sterilization apparatus, and raw water ozone-treated with the ozone sterilization apparatus is supplied to the culture beds.

In addition, Patent Document 2 discloses an ozone sterilization apparatus for hydroponic culture. The sterilization apparatus is equipped with a culture solution tank storing culture solution circulation-supplied to plant culture channels, an ozone water production tank for producing ozone water supplied to the culture channels and an ozone generator. With this configuration, the culture solution from the culture channels is accumulated in the culture solution tank, and the culture solution in the culture solution tank is ozone-treated. The culture solution in the culture solution tank and the ozone water in the ozone water production tank are alternately supplied to culture plants in the culture channels.

### PRIOR ART DOCUMENT

### Patent Document

Patent Document 1: JP-A 2001-299116

Patent Document 2: JP-A 2002-191244

### SUMMARY OF THE INVENTION

### Problems the Invention Intends to Solve

However, since the nutrient circulation system 1 of FIG. 14 does not have a function to purify the nutrient solution 10, in case a disease should spread in the culture beds 3, there is a possibility of pathogenic bacteria in the nutrient solution 10 within the nutrient solution reservoir 2 growing. In this case, since ground water or clean water is generally utilized as makeup water to be resupplied to the nutrient solution 10, the number of the pathogenic bacteria is reduced. However, circulation of the nutrient solution 10 allows the pathogenic bacteria hiding in the culture beds 3 to spread over the entire system, thereby possibly delaying the growth of the plants or annihilating the plants.

The nutrient solution circulation system 11 shown in FIG. 15 is provided with the purification apparatus 12 to purify the nutrient solution 10 and prevent a disease from being spread. In the nutrient solution circulation system 11, however, since the purification apparatus 12 is connected to the nutrient solution reservoir 2 and since the entire nutrient solution 10 within the nutrient solution reservoir 2 is purification-treated with the purification apparatus 12, the components of the nutrient solution resupplied possibly change. In addition, since the purification apparatus 12 is used to perform the ozone treatment and ultraviolet-ray treatment, the iron or Mn component of the nutrient solution 10 is subjected to oxidation and precipitation to possibly change the physical properties of the entire nutrient solution. Therefore, it has been needed to periodically resupply an iron or Mn component to the nutrient solution 10.

On the other hand, in Patent Document 1, when ozone treatment has been performed only with the ozone sterilization apparatus, the nutrient solution is likely to be acidified to possibly make the pH regulation difficult and induce a ozone fault relative to the plants. In addition, the acidification has caused the plumbing system to corrode and the plants to induce a growth defect. In the case where the hollow fiber membrane module is used to perform drainage water sterilization and impurity removal, it has been necessary to frequently carry out cleaning in order to prevent clogging due to sliminess of organic substances.

Also in the sterilization apparatus of Patent Document 2 for hydroponic culture, since the sterilization has been performed only with supplied ozone, the culture solution has been likely to be acidified to make the pH control difficult. Moreover, since the ozone concentration is thick, there is a possibility of an ozone fault being induced similarly to Patent Document 1.

The present invention has been developed in view of the aforementioned state of affairs and in consequence of keen studies, and the object thereof is to provide a nutriculture system that enables the circulation of a nutrient solution while preventing the proliferation of pathogenic bacteria and can promote the growth of plants effectively and steadily while preventing the change in components of the nutrient solution and to provide a water treatment apparatus for sterilization and purification purposes, which is made compact in size.

### Means for Solving the Problems

To attain the above object, the invention according to claim 1 relates to a nutriculture system for circulating a culture solution that is a liquid fertilizer between a nutrient solution tank containing the culture solution and culture beds, which comprises a water treatment apparatus disposed between the nutrient solution tank and the culture beds for sterilizing and purifying only a culture solution having flowed through the culture beds, wherein the water treatment apparatus comprises a unit having an ozone supply function for supplying ozone to the culture solution, an ultraviolet ray irradiation function for irradiating the culture solution with ultraviolet rays, and a photocatalyst-acting function for allowing a photocatalyst to act.

The invention according to claim 2 relates to the nutriculture system further comprising an effluent tank disposed on an upstream side of the nutrient solution tank for containing the culture solution having flowed through the culture beds and a sterilization and purification unit connected to the effluent tank.

The invention according to claim 3 relates to the nutriculture system wherein the sterilization and purification unit is provided with a branched flow passage for supplying directly to the effluent tank the culture solution having been sterilized and purified with the sterilization and purification unit.

The invention according to claim 4 relates to a water treatment apparatus for sterilization and purification purposes, comprising a discharge ozonizer, a separate reaction vessel having an ultraviolet lamp embedded therein, and an air separator with an air vent valve with which ozone water having ozone produced with the ozonizer mixed with treated water is effluent-ozone degassed to form treatment ozone water that is supplied the reaction vessel.

The invention according to claim 5 relates to a water treatment apparatus for sterilization and purification purposes, wherein the reaction vessel has a flow passage provided therein with a photocatalyst.

The invention according to claim 6 relates to a water treatment apparatus for sterilization and purification purposes, wherein the air vent valve of the air separator has a degassing port provided with a cleaning rod operable from outward.

### Effects of the Invention

According to the invention set forth in claim 1, by sterilizing and purifying the culture solution with the water treatment apparatus having the ozone supply function, ultraviolet ray irradiation function and photocatalyst-acting function to produce a synergistic effect, by which a strong sterilization action and an organic decomposition action are manifested to enable the nutrient solution to be circulated while suppressing the proliferation of pathogenic bacteria. At this time, since only the culture solution having flowed through the culture beds can be sterilized and purified, it is possible to prevent the components of the nutrient solution from being changed to contribute steadily to the effective growth promotion of the plants. Furthermore, since space-saving of the entire system can be realized and since the running cost is suppressed, the present invention is excellent in economy.

Particularly, since the water treatment apparatus of the present invention is of a promotion and oxidation type, ozone is appropriately decomposed to obtain an effect of steadily utilizing the apparatus. As a result, a sterilization effect and a function of adding dissolved oxygen are attained to exert a promotion effect of plant growth.

According to the invention set forth in claim 2, since the culture solution having flowed through the culture beds accumulated in the effluent tank is sterilized and purified and the resultant culture solution is supplied to the nutrient solution tank, it is possible to maintain the state in which the culture solution in the nutrient solution tank has flowed to enable the culture effect by the culture solution to be heightened.

According to the invention set forth in claim 3, since culture solution sterilized and purified with the sterilization and purification unit can be sent directly to the nutrient solution tank, a time lag up to the supply of the culture solution to the nutrient solution tank is smaller than in the case where the culture solution once accumulated in the effluent tank is sterilized and purified, it becomes possible to supply the sterilized and purified culture solution to the nutrient solution tank immediately from the operation start.

According to the invention set forth in claim 4 or 5, the separation structures of the ozonizer and reaction vessel produce the following effects. To be specific, a large amount of ozone is needed when a fluid contains many organic substances. Even in such a case, addition in number of ozonizers enables ozone to be produced twice or thrice. Inversely, when the amount of residual ozone in the fluid is increased, addition of the reaction vessel (ultraviolet lamp) proceeds with promotion oxidation and decomposition of the residual ozone can treat the fluid more steadily.

In addition, since the electrode portion of the ozonizer is exposed to strong oxidation, the operation life thereof is shorter than other equipment. However, since the present invention adopts the separate structures, the electrode portion etc. can be exchanged extremely easily.

Integral formation of the apparatus results in a product of particularly high capacity or high output to make it difficult to form a minute gap of quartz glass and need an expensive dual quarts glass. However, the separate structures adopted in the present invention make it sufficient that only the ultraviolet transmission portion is made of quarts glass.

Furthermore, since the separate structures are adopted in the present invention, a glass tube (borosilicate glass tube, for example) for generating the same amount of ozone can be made small. In addition, since the high-pressure electrode can be produced by metal processing, the dimension stability can be enhanced dramatically. Therefore, ozone is stably produced steadily.

According to the invention set forth in claim 6, it is possible to eliminate clogging by a calcium component and carry out clogging prevention with ease.

### BRIEF DESCRIPTION OF THE DRAWINGS

FIG. 1 is a view showing a frame format of the first embodiment of a nutriculture system according to the present invention.

FIG. 2 is a schematic cross section showing an example of a water treatment apparatus for sterilization and purification purposes.

FIG. 3 is a schematic cross section showing an ozonizer in FIG. 2.

FIG. 4 is a schematic cross section showing an ultrasonic ray-photocatalyst unit in FIG. 2.

FIG. 5 is a view showing a frame format of the second embodiment of the nutriculture system according to the present invention.

FIG. 6 is a view showing a frame format of the third embodiment of the nutriculture system according to the present invention.

FIG. 7 is a view showing a frame format of an example of a water treatment apparatus according to the present invention provided with a pH regulator.

FIG. 8 is a schematic cross section showing another example of the water treatment apparatus.

FIG. 9 is a cross section showing an ejector.

FIG. 10 is a cross section showing an air vent valve.

FIG. 11 is a cross section showing an example of a gas-liquid separator.

FIG. 12 is a cross section showing another example of the gas-liquid separator.

FIG. 13 is a view showing a frame format of a state in which a nutrient solution is cleaned with and circulated in the water treatment apparatus.

FIG. 14 is a view showing a frame format of an example of a conventional nutrient solution circulation system.

FIG. 15 is a view showing a frame format of another example of the conventional nutrient solution circulation system.

### MODE FOR CARRYING OUT THE INVENTION

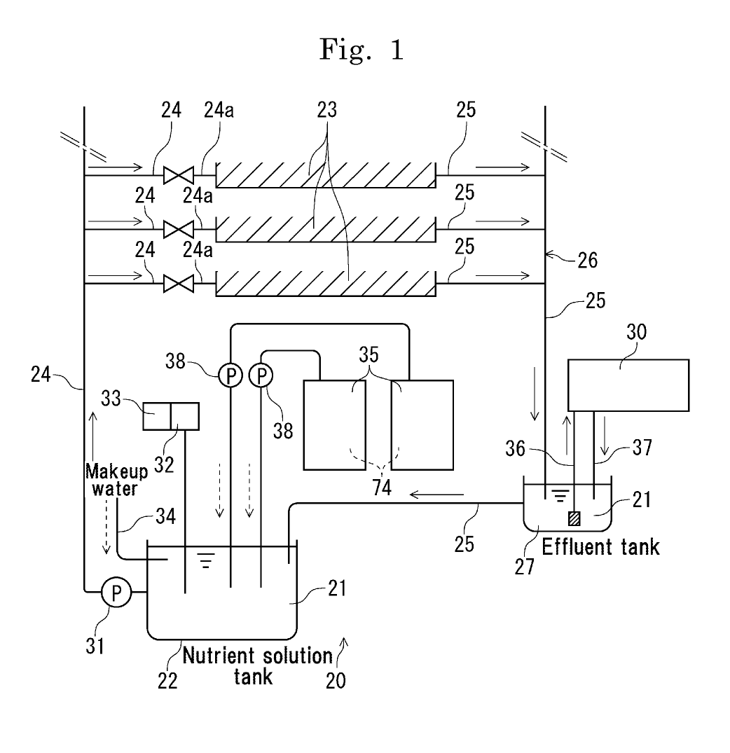

Embodiments of a nutriculture system according to the present invention and a water treatment apparatus used, for example in the system, for sterilization and purification purposes will be described hereinafter in detail with reference to the drawings. FIG. 1 is a view showing a frame format of the first embodiment of a nutriculture system according to the present invention. A nutriculture system main body (hereinafter referred to as the system main body) 20 is adapted to circulate a culture solution 21 that is a liquid fertilizer having nutrient contents dissolved therein between a nutrient solution tank 22 and culture beds 23 having unshown plants including strawberries and green onions planted therein. In the system main body 20, the nutrient solution tank 22 and culture beds 23 are connected to each other with supply lines 24 and return lines 25 to constitute a circulation line 26. To the circulation line 26 between the nutrient solution tank 22 and the culture beds 23, an effluent tank 27 and a water treatment apparatus 30 for sterilization and purification purposes are connected. In addition, besides these components, a circulation pump 31, a pH regulator 32, an EC regulator 33, a makeup water line 34 and nutrient solution mixers 35 are connected to the system main body 20.

The supply lines 24 in the system main body 20 are for supplying the culture solution 21 from the nutrient solution tank 22 to the culture beds 23, and the flow passage of each thereof is midway branched to form a nutrient solution slot 24a, from which the culture solution 21 can be supplied to the culture bed 2123. On the other hand, the return lines 25 are for returning the culture solution 21 from the culture beds 23 to the nutrient solution tank 23 and are connected to the nutrient tank 22 in a state in which they converge from the exit sides of the culture beds 23 into a single flow passage.

The effluent tank 27 is connected to between the supply lines 24 and the return lines 25 and disposed at a lower position on a downstream side from the culture beds 23 and at a higher position on an upstream side from the nutrient solution tank 22 in a state having a difference in height. The culture solution 21 having flowed through the culture beds 23 is accumulated in the effluent tank 27. The water treatment apparatus 30 is connected to the effluent tank 27, sterilizes and purifies only the culture solution 21 having flowed through the culture beds 23 and is adapted to supply the resultant culture solution to the nutrient solution tank 22.

In the figure, the water treatment apparatus 30 is connected to the effluent tank 27 with a nutrient solution supply line 36 and a nutrient solution return line 37. The culture solution 21 is supplied from the effluent tank 27 into the water treatment apparatus 30 via the nutrient solution supply line 36, sterilized and purified with the water treatment apparatus 30 and then returned to the effluent tank 27 via the nutrient solution return line 37.

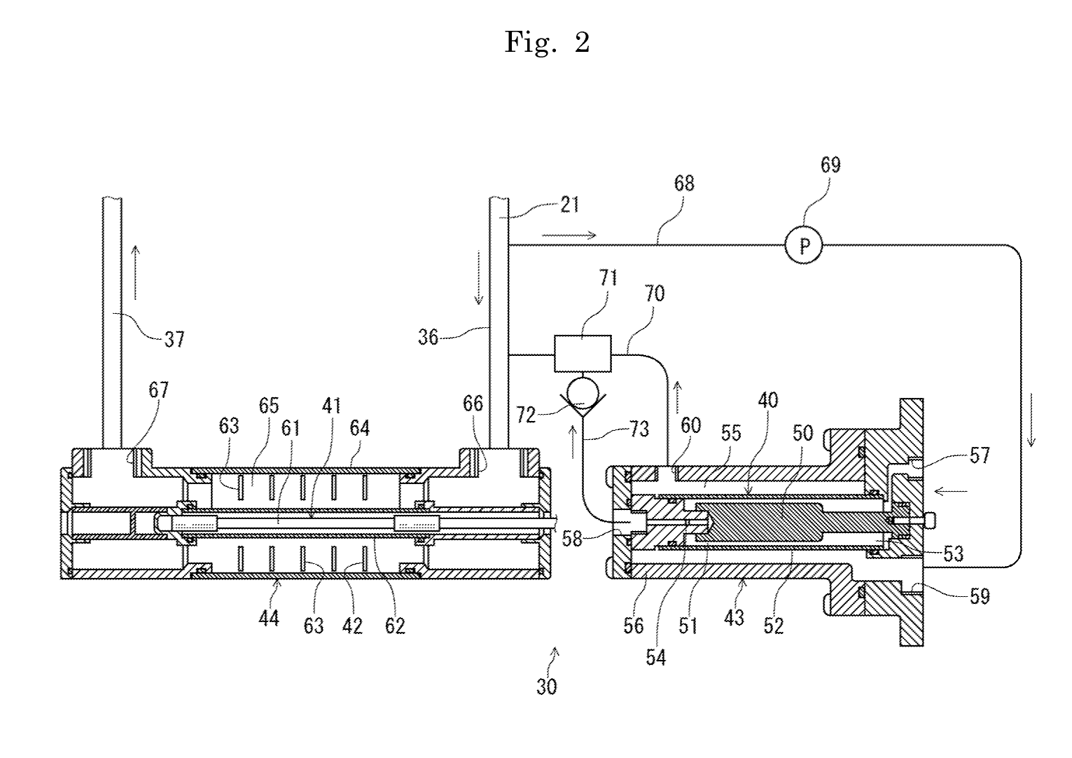

As shown in FIG. 2, the water treatment apparatus 30 has an ozone supply portion 40, an ultraviolet ray irradiation portion 41 and a photocatalyst action portion 42 and, as described later, it is structured that the ozone supply portion 40 supplies ozone to the culture solution 21, that the ultraviolet ray irradiation portion 41 irradiates ultraviolet rays onto the culture solution 21 and that the photocatalyst action portion 42 allows a photocatalyst to act on the culture solution 21. In the present embodiment, the ozone supply portion 40 is disposed in an ozonizer 43, and the ultraviolet ray irradiation portion 41 and photocatalyst action portion 42 in an ultraviolet ray-photocatalyst unit 44. The ozonizer 43 and ultraviolet ray-photocatalyst unit 44 are formed into separate units, and the ultraviolet ray-photocatalyst unit 44 is connected to a downstream side of the ozonizer 43 to constitute the water supply apparatus 30.

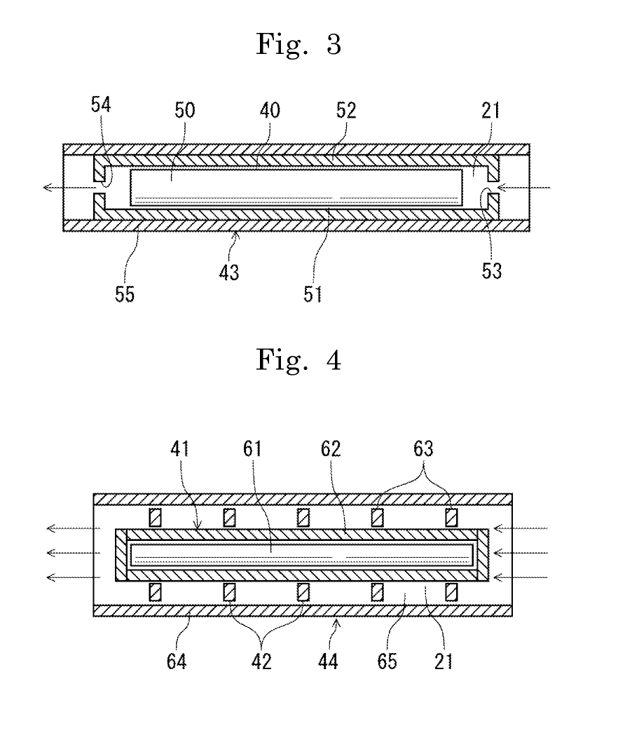

In FIG. 3, the ozone supply portion 40 (ozonizer 43) has at the center thereof a cylindrical metal bar 50, on the outer peripheral side of which a substantially cylindrical dielectric (insulator) 52 is disposed via a gap 51 of around 0.3 to 1.5 mm. The dielectric 52 is made, for example, of glass, ceramic or PTFE (PolyTetraFluoroEthylene) and provided on the entrance and exit sides thereof with a supply port 53 and a discharge port 54, respectively. In addition, the dielectric 52 is disposed so that the treated water flows onto the outer peripheral side thereof.

In the same figure, by charging the metal bar 50 with high-pressure electricity and allowing the treated water to serve as a ground electrode 55, silent discharge is induced in the space (gap) 51 between the metal bar 50 and the dielectric 52, and air or high-concentration oxygen is fed into the space 51 to constitute the ozonizer 43.

As shown in FIG. 2, the ozone supply portion 40 is stored in a storage casing 56 that is formed with an air entrance port 57 constituting the entrance of dried air, a gas discharge port 58 constituting the exit of the ozone gas, a nutrient solution entrance port 59 constituting the entrance of the high-pressure nutrient solution, and a nutrient solution discharge port 60 constituting the exit of the high-pressure nutrient solution. Of these ports, the air entrance port 57 communicates with the supply port 53, the gas discharge port 58 with the discharge port 54, and the air entrance port 57 with the gas discharge port 58 via the inside of the ozone supply portion 40. On the other hand, the nutrient solution entrance port 59 and nutrient solution discharge port 60 communicate with each other via the space between the storage casing 56 and the ozonizer 43. With this configuration, the ozonizer 43 produces ozone, with air or gas having a higher oxygen concentration than air as the raw material, and is connected to an ejector 71 described later for mixing the ozone with the nutrient solution together with dissolved oxygen in a foamed state.

In addition, two or three ozonizers 43 having the same concentration are disposed in parallel to enable the flow rate of ozone generation air or high-concentration oxygen to be increased. On the other hand, the ozonizers 43 are disposed in series to enable the ozone concentration to be heightened.

In FIG. 4, the ultraviolet ray-photocatalyst unit 44 has at the center thereof an ultraviolet source 61, and a protective cylinder 62 for protection is disposed on the outer peripheral side of the ultraviolet source 61. The ultraviolet source 61 is disposed so as to enable irradiation of ultraviolet rays and has a feature containing plenty of ultraviolet rays having wavelengths of 410 nm or less in order to effectively generate holes and electrons from photocatalysts 63. As the ultraviolet source 61, an ultraviolet lamp or low-pressure or high-pressure mercury lamp is used, for example. Otherwise, a fluorescent lamp having a wavelength of 250 to 400 nm or plural LEDs arranged for irradiating ultraviolet rays may be used. When the LED lamp is used as the ultraviolet source, it is possible prolong the operation life of and attain the miniaturization of the light source main body. Furthermore, it is possible to suppress the amount of heat generation and perform effective purification. Moreover, though not shown, the shape of the ultraviolet source may be selected from a straight-line (linear) shape, a circular cylindrical (circular) shape, a spiral shape and a waveform shape. The selection of any of the shapes enables the photocatalysts 63 to function effectively.

The protective cylinder 62 on the outer periphery of the ultraviolet source 61 is formed of quartz glass, borosilicate glass or high silica glass, for example. Of these, particularly the borosilicate glass and high silica glass are comparatively inexpensive and can be used without modification. From the standpoints of ultraviolet ray transmission, heat resistance and strength, however, quartz glass is the best material. An outer cylinder 64 having a predetermined inside diameter is disposed on the outer peripheral side of the protective cylinder 62, and a flow passage 65 of the nutrient solution 21 is formed between the outer cylinder 64 and the protective cylinder 62. The flow passage 65 is provided therein with the photocatalysts 63.

The photocatalysts 63 are made of titanium dioxide, for example and formed on the front side of a material including titanium or titanium alloy including an unshown mesh, titanium line, aggregate of fibrous titanium materials or porous titanium material. The material is formed into a slender shape to enable a reaction area to be enlarged and make the reactivity the ozone good. The material may be a material other than titanium or titanium alloy. For example, it may be glass or ceramic and, on the surface of which the photocatalysts may be formed.

In the present embodiment, since the ultraviolet ray-photocatalyst unit 44 is provided at the center thereof with the ultraviolet source 61, it is possible to make the entire unit compact in size and effectively perform the irradiation of the ultraviolet rays from the ultraviolet source 61 onto the culture solution 21. Though not shown, the ultraviolet ray-photocatalyst unit may be provided on the outside thereof with the ultraviolet source and on the inside thereof with the photocatalysts. In this case, the nutrient solution 21 flows inside of the protective cylinder.

As shown in FIG. 2, the ultraviolet ray-photocatalyst unit 44 is provided with an entrance-side connection port 66 and an exit-side communication port 67 to which the nutrient solution supply line 36 and nutrient solution return line 37 are connected, respectively. Furthermore, the nutrient solution supply line 36 is provided with a bypass flow passage 68, the secondary side of which is connected to the nutrient solution entrance port 59. The bypass fluid passage 68 is provided midway with a pressure application pump 69, with which part of the culture solution flowing through the nutrient solution supply line 36 is supplied from the bypass flow passage 68 to the ozonizer 43.

In addition, the secondary side of the nutrient solution supply line 36 far from the bypass flow passage 68 is provided with a return flow passage 70. With the return flow passage 70, the nutrient solution supply line 36 and nutrient solution discharge port 60 are connected to each other. Furthermore, the return flow passage 70 is provided midway with the ejector 71 that is connected via a check valve 72 to the gas discharge port 58 with a gas supply passage 73.

The check valve 72 is provided in an appropriate manner and disposed for preventing a counter flow of ozone or oxygen supplied from the ozonizer 43. In addition, the ejector 71 is made, for example, of ceramic, metal or resin and formed in the shape of a ring for mixing the nutrient solution flowing from the return flow passage 70 with the ozone (and oxygen or air) flowing from the gas supply passage 73, thereby producing a mixed solution (ozone water) in a finely foamed state. At this time, the ozone and oxygen or air having flowed through the check valve 72 increase their flow rates in the presence of an unshown overflow passage in the ejector 71, are supplied to the nutrient solution supply pipe 36 and are dissolved in the nutrient solution in a foamed state.

On the other hand, in FIG. 1, a circulation pump 31 of the system main body 20 is for pumping up the culture solution 21 within the nutrient solution tank 22 and supplying the same to the culture beds 23. The return lines 25 are constituted so that the pumped-up culture solution 21 having flowed through the culture beds 23 may be allowed to flow the effluent tank 27 on the downstream side and then flow to the nutrient tank 22 on the downstream side of the effluent tank 27.

The pH regulator (pH sensor) 32 is disposed for regulating the pH of the nutrient solution in the nutrient solution tank 22 and may be a generally used one. In the present embodiment, the pH regulator 32 is used to regulate the pH of the culture solution 21 in the nutrient solution tank 22 to around 6 to 6.5, for example. In addition, the EC regulator 33 is disposed for regulating the EC (Electrical Conductivity) of the nutrient solution in the nutrient solution tank 22 and may be a generally used one similarly to the pH regulator 32. When regulating the EC of the culture solution 21 with the EC regulator 33 to appropriate values, EC=0.5 in the case of strawberries and EC=1.0 in the case of tomatoes.

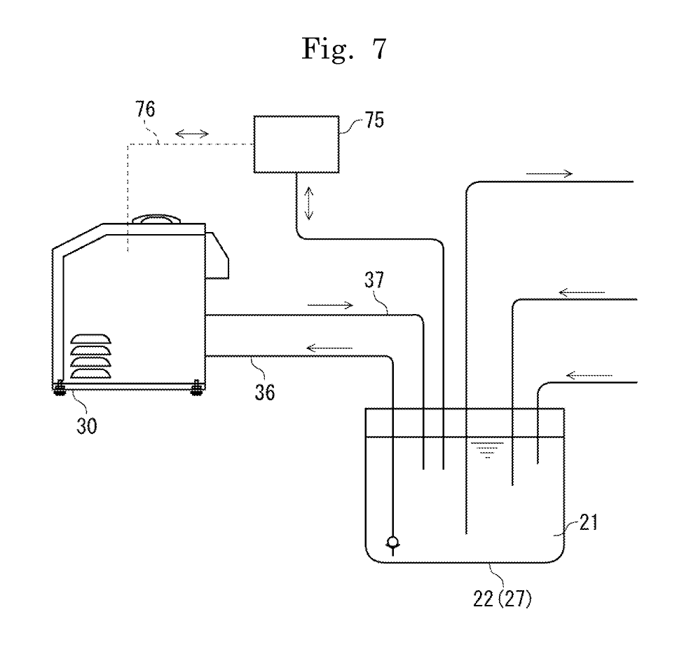

FIG. 7 shows an example of the structure of the present invention that is provided with a pH sensor (pH regulator). In the same figure, the pH sensor 75 is for measuring the pH of liquid and, based on the liquid pH measured with the pH sensor 75, one or more of the ozone supply portion 40, ultraviolet ray irradiation portion 41 and photocatalyst action portion 42 is/are operated so that the liquid pH may approximate a set value set beforehand.

The pH sensor 75 sends to and receives from the water treatment apparatus 30 control signals 76 that include a signal for stopping the ozone supply portion 40 and operating the ultraviolet ray irradiation portion 41 and photocatalyst action portion 42 until acidic liquid approximates alkaline liquid and a signal for stopping the ultraviolet ray irradiation portion 41 and photocatalyst action portion 42 and operating the ozone supply portion 40 until alkaline liquid approximate acidic liquid.

The regulation methods using the pH regulator 75 include, besides the above example, intermittently operating the ozone supply portion 40, the ultraviolet ray irradiation portion 41 and photocatalyst action portion 42 and finely regulating the amount of ozone or ultraviolet rays appropriately, thereby controlling the pH value.

The makeup water line 34 is disposed for resupplying water to the nutrient solution tank 22 and, when the culture solution 21 has been reduced in amount because of the supply to the culture beds 23, an appropriate amount of water is resupplied via the makeup water line 34 to the nutrient solution tank. As a result, it is possible to compensate for the deficient amount of culture solution 21 and supply the culture solution 21 to the plants steadily.

The nutrient solution mixers 35 are connected to the nutrient solution tank 22 via supply pump 38 and unshown quantitative injectors, and a liquid fertilizer 74, for example, is accumulated in the nutrient solution mixers 35 as an undiluted solution constituting the component of the culture solution 21. When the amount of the culture solution 21 in the nutrient solution tank 22 decreases and when water is resupplied via the makeup water line 34 thereto, the pH and EC are measured with the pH regulator 32 and EC regulator 33, and the undiluted solution 74 having a predetermined ratio is appropriately injected from the nutrient solution mixers 35 into the nutrient solution tank so that the measured pH and EC may have the appropriate values, respectively.

The water treatment apparatus 30 may have an unshown timer embedded therein to use the timer to turn the operation on and off, perform intermittent operation or change the ozone concentration to control the amount of ozone to be supplied from the water treatment apparatus 30. In this case, it is possible to supply an appropriate amount of ozone, prevent acidification of the culture solution 21 due to excessive supply of ozone and prevent corrosion of the plumbing system and growth defect of the plants. In addition, an unshown feed pump may be disposed between the effluent tank and the nutrient solution tank. In this case, the culture solution 21 in the effluent tank 27 can be fed to the nutrient solution tank 22 without forming any difference in height between the effluent tank 27 and the nutrient solution tank 22.

Next, the function of the above embodiment will be described. In FIG. 1, the first embodiment will be described. When the system main body 20 is operated, the culture solution 21 in the nutrient solution tank 22 is pressurized by the circulation pump 31, sent under pressure to the supply line 24 and supplied to the culture beds 23 from the nutrient solution slots 24a. The supply of the culture solution 21 promotes the growth of the plants in the culture beds 23. Subsequently, the culture solution 21 flows to freely fall in the effluent tank 27 on the downstream side via the return lines 25 because of the difference in height between the culture beds 23 and the effluent tank 27.

In FIGS. 1 and 2, the culture solution 21 accumulated in the effluent tank 27 is sterilized and purified with the water treatment apparatus 30. In this case, when the culture solution 21 flows into the water treatment apparatus 30, it flows through the nutrient solution supply line 36 and is supplied to the ultraviolet ray-photocatalyst unit 44 from the entrance-side connection port 66. At this time, part of the culture solution 21 flows from the nutrient solution entrance port 59 into the ozonizer 43 via the bypass flow passage 68.

In the ozonizer 43, air or gas having a higher oxygen concentration than air is supplied as the raw material from the air entrance port 57, with the metal bar 50, to which voltage is applied from an unshown high-pressure power supply in the ozone supply portion 40, charged with high pressure flows in the gap 51. At this time, the gap 51 constitutes a discharge space in the presence of the metal bar 50, dielectric 52 and ground electrode 55 to produce ozone in the gap 51. The ozone is discharged from the gas discharge port 58 via the discharge port 54 and, by the action of the ejector 71, mixed together with oxygen or air in the nutrient solution flowing through the nutrient solution supply line 36 from the return flow passage 70.

The culture solution 21 subsequently flows into the ultraviolet ray-photocatalyst unit 44 along with a culture solution that does not flow through the bypass flow passage 68. When the culture solution 21 passes through the ultraviolet source 61 and photocatalysts 63, it is sterilized and purified by means of the ultraviolet rays from the ultraviolet ray irradiation portion 41 and the photocatalyst action of the photocalysist action portion 42. In this case, the photocatalysts 63 enhances their photocatalytic action functions through the irradiation of the ultraviolet rays and have a higher sterilization-ability than ozone and an organic substance-decomposing ability.

The principle of the sterilization and purification actions by the photocatalysts 63 at this time will be described. When ultraviolet rays having a wavelength of 400 nm or less are irradiated onto the photocatalysists 63 made of titanium dioxide, etc., holes are generated in a valence band and, at the same time, electrons are generated in a conductance band. Since the oxidation potential of the holes is higher than that of ozone, hydrogen peroxide, etc., organic substance is completely oxidation-decomposed by photocatalyst action, finally into carbon dioxide and water completely. The photocatalyst 63 makes oxidation reaction by a hydroxyl radical (OH radical) rich in extremely reaction activity induced by reaction of holes produced when being irradiated with ultraviolet rays or the holes and water. At this time, reduction reaction among the holes induced in consequence of the irradiation of the ultraviolet rays, simultaneously generated electrons and oxygen gas proceeds in parallel.

Owing to the strong oxidation reaction, the photocatalyst 63 can exhibit a stronger sterilization ability than a conventional sterilizer, such as ozone, hydrogen peroxide, chlorine, etc. and has an ability to decompose organic substances. Furthermore, since the duration of life of the holes or OH radicals generated by irradiation is short, e.g. ns, the holes or OH radicals do not stay behind after treatment unlike an oxidizing agent including ozone, hydrogen peroxide, etc. Therefore, it is unnecessary to use any apparatus for treating a residual oxidizing agent. This is advantageous. In view of the above, the photocatalyst 63 can effectively sterilize and purify a mixed substance difficult to purify with the ozone remaining in the culture solution 21. In addition, since irradiation of ozone with ultraviolet rays produces OH radicals, it is possible to obtain a higher promotion oxidation effect.

Next, in FIG. 1, the culture solution 21 having been sterilized and purified with the water treatment apparatus 30 flows to freely fall from on the downstream side owing to the difference in height between the effluent tank 27 and the nutrient solution tank 22 and is accumulated in the nutrient solution tank 22. Then, water is added from the makeup water line 34 and an undiluted solution 74 is added from the nutrient solution mixers 35 to the sterilized and purified culture solution 21, the pH value and EC value of which are regulated with the pH regulator 32 and EC regulator 33 to regulate the culture solution 21 to an appropriate state.

Since the nutriculture system of the present invention has the water treatment apparatus 30 disposed between the nutrient solution tank 22 and the culture beds 23 and since only the culture solution 21 having flowed through the culture beds 23 is sterilized and purified on the upstream side of the nutrient solution tank 22 with the water treatment apparatus 30, it is possible to prevent the culture solution 21 containing pathogenic bacteria from being mixed in the culture solution in the nutrient solution tank 22 and prevent a change in component of the culture solution 21 in the nutrient solution tank 22. In addition, since the iron or Mn component of the culture solution 21 in the nutrient solution tank 22 is little oxidized and precipitated, it is unnecessary to resupply an iron or Mn component to the culture solution 21.

Furthermore, since the culture solution 21 is accumulated in the effluent tank 27, sterilized and purified in the effluent tank 27 and caused to flow into the nutrient solution tank 22, the culture solution 21 in the nutrient solution tank 22 can always be circulated to the circulation line 26.

Since the water treatment apparatus 30 utilizes the ozone supply function, ultraviolet ray irradiation function and photocatalyst action function to enable the culture solution 21 having flowed through the culture beds 23 to be sterilized and purified, their synergistic effect enables highly effective sterilization and purification. For example, the water treatment apparatus 30 can suppress the amount of ozone generated, purifies the culture solution 21 while supplying ozone steadily to prevent acidification. As a result, it is easy to perform the pH regulation and possible to prevent ozone obstacles of the plants. Furthermore, it can prevent corrosion of the plumbing system and growth defect of the plants only require periodic resupply of nutrient elements, thereby making it possible to produce a high yield of plants. Furthermore, since a minute amount of ozone can always be supplied, it is possible to suppress the growth of bacteria on the inner walls of the plumbing system and the biofilm development

Furthermore, since the water treatment apparatus 30 can always treat organic substances, clogging, corrosion and sliminess of the culture beds 23 by the organic substances are prevented, and the growth of the roots is promoted to enhance the growth of the plants. When the plants are strawberries, for example, corrosion of the roots of strawberries reduces the number of harvests. Since the root corrosion is prevented, stable harvests over a long period of time can be attained. In addition, since occurrence of organic substances is reduced, postharvest cleaning of the culture beds 23 is made easy.

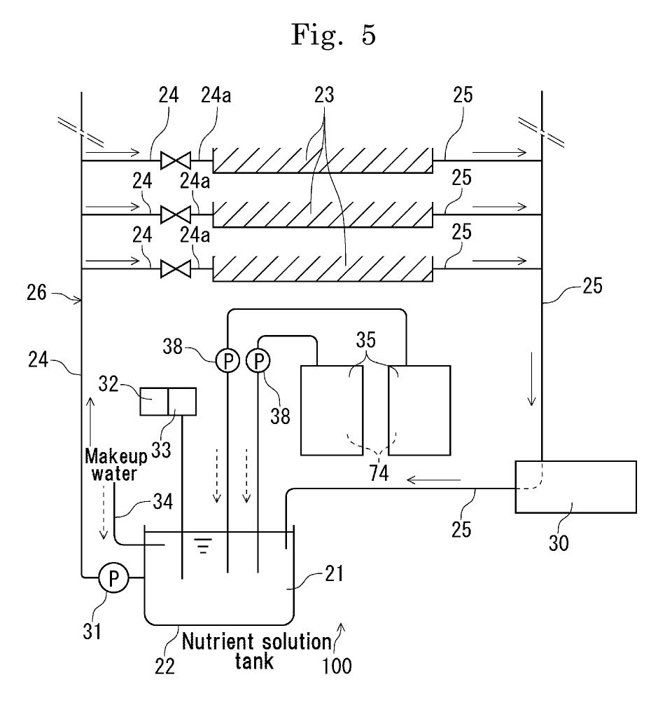

FIG. 5 shows the second embodiment of the nutriculture system according to the present invention. The portions in the following embodiments the same as in the first embodiment are denoted by the same reference numerals and the explanations thereof are omitted. A system main body 100 in the second embodiment has a water treatment apparatus 30 connected directly between culture beds 23 and a nutrient solution tank 22, and a culture solution 21 sterilized and purified with the water treatment apparatus 30 is allowed to flow into the nutrient solution tank 22. In this case, since the culture solution is allowed to flow in the absence of an effluent tank, flow passages in the system main body 100 can be simplified, and the system is advantageous from the viewpoints of compactness and cost.

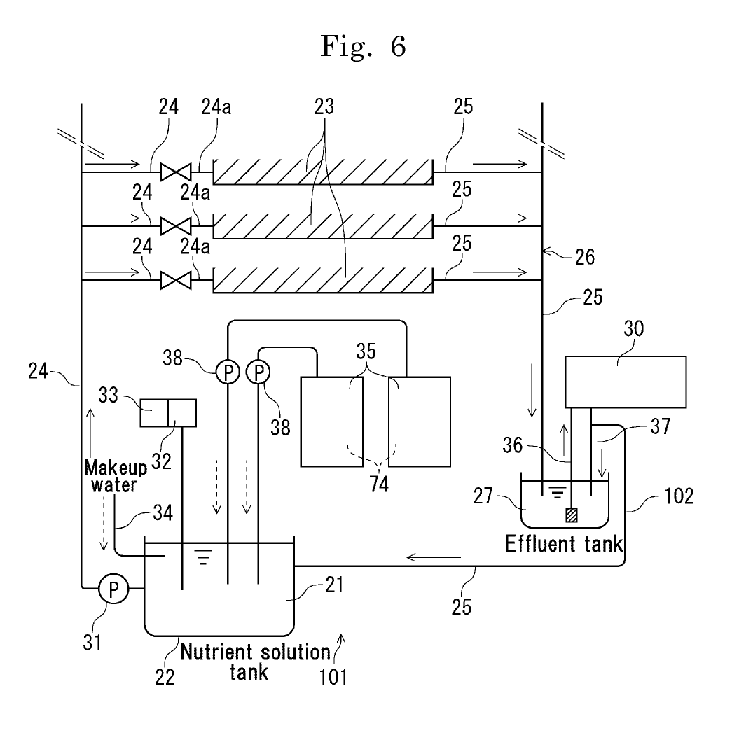

FIG. 6 shows the third embodiment of the nutriculture system according to the present invention. In a system main body 101 of the present embodiment, a water treatment apparatus 30 is connected to an effluent tank 27 with a nutrient solution supply line 36 and a nutrient solution return line 37, and a flow passage 102 is branched from the nutrient solution return line 37 and connected to a nutrient solution tank 22 on the downstream side. With this configuration, since a culture solution 21 sterilized and purified with the water treatment apparatus 30 is supplied directly to the effluent tank 27 via the branched flow passage 102, it is unnecessary to supply the entire culture solution 21 accumulated in the effluent tank 27 to the nutrient solution tank 22, and it is possible to supply to the nutrient solution tank 22 the culture solution 21 having been sterilized and purified immediately after the operation start of the system main body 101.

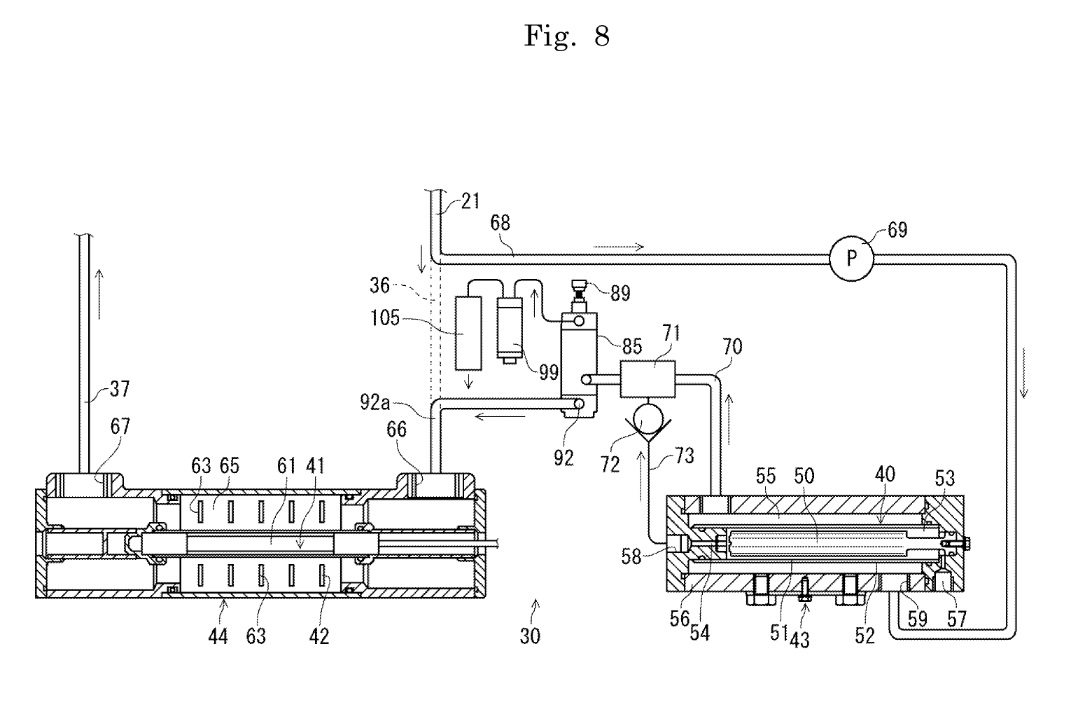

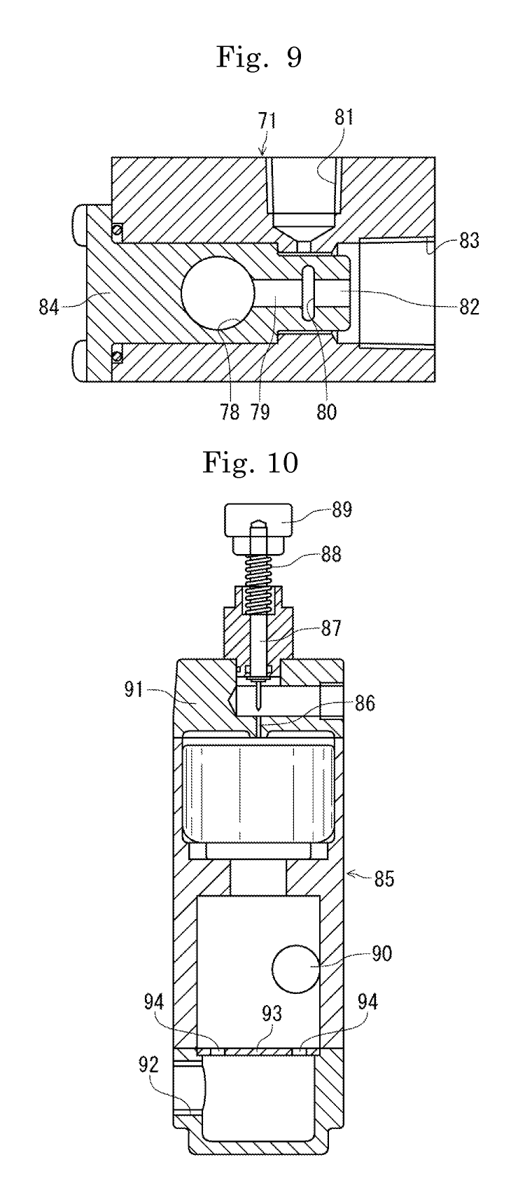

FIG. 8 shows another example of the water treatment apparatus shown in FIG. 2, and the same portions are denoted by the same reference numerals and the explanations thereof are omitted. In FIG. 8, when liquid of high pressure (around 0.1 MPa to 1 MPa) is fed from a liquid feed port 78 of an ejector 71, it flows through a pathway 79 at high speed. At this time, the liquid from a slit 80 of the ejector 71 in FIG. 9 engulfs gas from a gas feed port 81 and mixes the gas in a pathway 82, gas-liquid mixed liquid is discharged from an exit 83. Conventionally, since liquid and gas have been mixed in a 180-degree flow passage in an ejector or venturi tube, a flow rate in a state of plumbing has not easily been changed. In the structure of the present invention, a bend of the flow passage by 90 degrees facilitates an exchange of a nozzle portion 84 and enables a flow rate change or cleaning even in the state of plumbing. When the nozzle portion 84 is detached, cleaning can be performed extremely easily.

Since the ejector 71 narrows a flow passage, the pathway 79 in FIG. 9 is possibly clogged with extraneous material in a fluid. Even in this case, since only the nozzle portion 84 can be detached from a structural point, the inside can easily be cleaned.

In the ozonizer utilized in the experiment, the ozone concentration and the current value have a substantially proportional relation until 1.1 A, and a mere change of the current value can regulate the ozone concentration. In addition, since the current value and ohmic value also have a proportional relation, the ozone concentration can easily be changed by changing the current value with a variable resistor (volume etc.).

Use of appropriate voltage with the electrode bar shown in FIG. 8 secures a stable amount of ozone generated even under internal pressure in a wide range. On the other hand, use of a power supply not conforming to a dual glass tube or source voltage induces a great change by the internal pressure.

In the ozonizer of the present invention shown in FIG. 8, the gap, which is a discharge space, between the high-voltage electrode bar and the insulator (glass tube) has a width of around 0.2 to 1 mm, and use of around 8 Kv to 15 Kv as the high-pressure power supply enables high-concentration ozone to be produced under an internal pressure in a wide range.

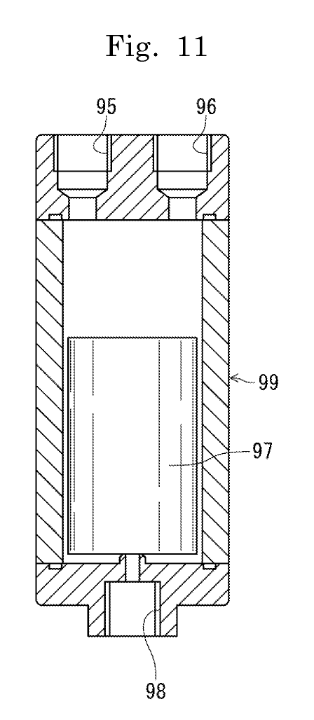

An air separator 85 with an air vent valve shown in FIG. 10 is formed with an air vent hole 86 and, since gas and liquid are mixed at this portion, the portion is clogged easily with a component, such as calcium or silica. A clogging prevention apparatus utilizing a cleaning bar 87 is provided at the portion. As a result, clogging is eliminated, and the air separator satisfies a function of air vent for a long period of time. Therefore, since clogging prevention is attained with the cleaning bar 87, the air separator 85 with the air vent valve is suitably used for purifying a hot spring containing calcium, silica or saline matter similarly to the culture solution. Incidentally, denoted by reference numeral 89 is a button having a spring 88 attached thereto.

In the air separator 85 with the air vent valve shown in FIG. 10, a gas-liquid mixed solution makes inroads from an eccentric introduction inlet 90 and is rotated to allow the liquid to go outward and the gas to be collected inward. The collected gas is discharged outside via the hole in an air vent valve 91. The separated water goes out from a liquid exit 92. At this time, the presence of a baffle plate 93 having a communication hole 94 enables the gas and liquid to be clearly separated. The adoption of this structure enables the gas and liquid to be very simply separated.

In a gas-liquid separator 99 shown in FIG. 11, a gas-mixed fluid (fluid composed mainly of gas) enters from an entrance 95 to collect a liquid content in the bottom and discharge the gas from a gas exit 96. When the liquid stands to some extent, a float 97 floats to discharge the liquid from a liquid exit 98.

As described earlier, in FIG. 8, the ozone water deprived of the wasted ozone gas in the liquid having gas and liquid mixed by means of the ejector 43 is supplied to the reaction vessel 44 via a supply line 92a. At this time, the water separated with the air separator 85 with the air vent valve is supplied from the liquid exit 92 to the reaction vessel 44 and, on the other hand, the gas and liquid are discharged with the gas-liquid separator 99, the gas enters an ozone treatment vessel 105 from the gas-liquid separator 99, and the air treated with ozone is discharged in the ambient air.

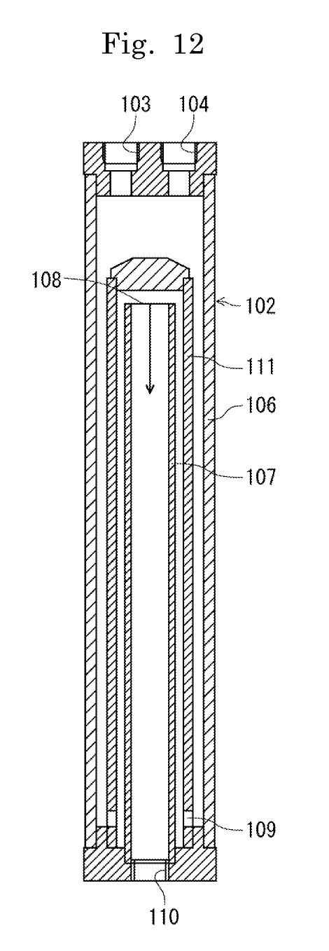

FIG. 12 shows another example of a gas-liquid separator 102. Gas containing water drops enters from a gas-liquid mixed gas entrance 103 and, when the water drops have stood up to an uppermost liquid surface 108, the liquid is drained from a drain outlet 110 and the gas is discharged from a gas exit 104. This feature results in that sealing is generally accomplished with a float with a rubber plug in a gas-liquid separator. In this case, when a hole is large, both gas and liquid go out from the hole. In addition, since the hole-diameter cannot be made large, when plenty of liquid has entered from the gas-liquid mixed gas entrance, drainage has been insufficient to possibly cause liquid to go out from the gas exit. Since liquid overflowing from the uppermost liquid surface can be discharged utilizing the inside diameter of an inner tube, even when a large quantity of liquid enters from the entrance, the amount of liquid discharged is large to avoid the liquid from go out from the gas exit. Since an outer tube 106, intermediate tube 111 and inner tube 107 can be formed of commercially available vinyl chloride, the product cost can be suppressed. When the gas exit 104 has clogged and when the liquid having stood inside has been pushed and drained from the drain outlet 110, right up to the end, the gas is discharged from the drain outlet 110. In such a case, only by making the length of the tube large, it is possible to increase resistance to clogging of the gas exit 104. Since sealing by a rubber plug is not carried out, durability becomes high.

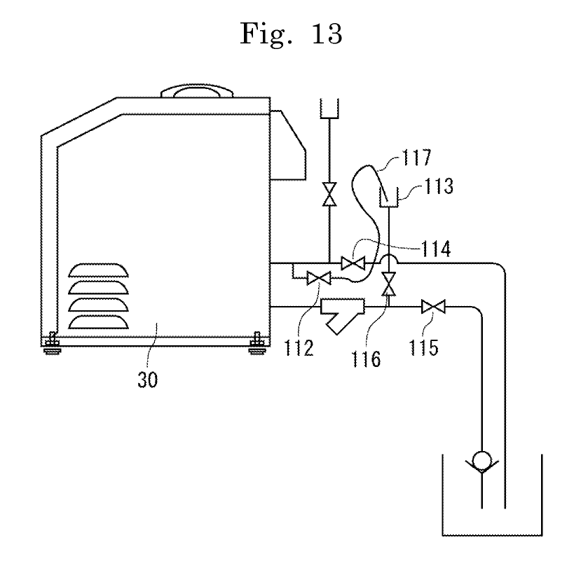

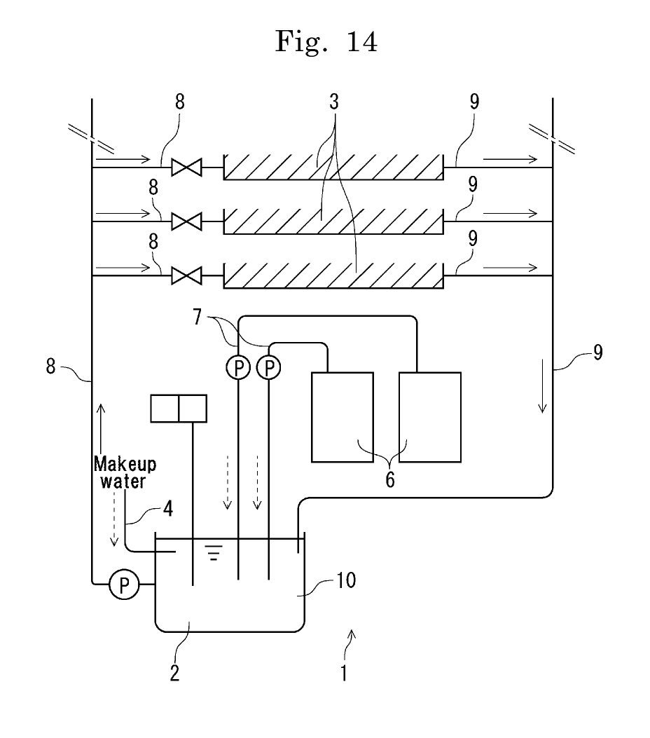

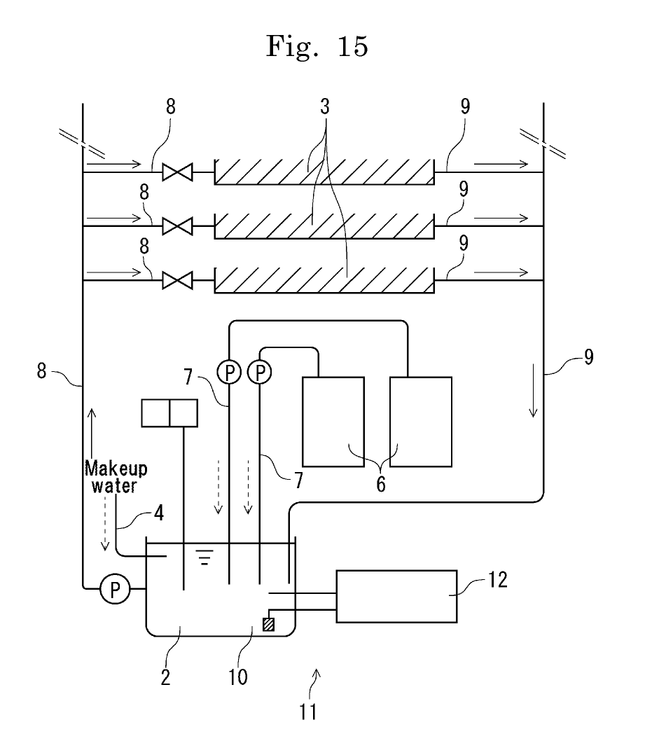

FIG. 13 shows a plumbing example in which citric acid cleaning is carried out while performing circulation. An ordinary nutrient solution (fertilizer) contains minute amounts of elements including iron, manganese, etc. besides the three major nutrients, i.e. nitrogen, phosphoric acid and potassium. The iron and manganese are crystallized out by the effect of ozone or an ultraviolet lamp as iron oxide and manganese oxide. These oxides adhere to the glass tube and photocatalysts to lessen the effect of promotion oxidation. Such a phenomenon possibly occurs in a hot spring or mineral spring depending on the kind of the components. In this case, the steps of detaching plumbing and carrying out cleaning are inconvenient and impracticable. In such a case, citric acid cleaning is performed. Conventionally, plumbing has been soaked in a citric acid before being washed. This has taken around one hour. In view of these problems, it has been found that citric acid cleaning while performing circulation can be carried out for a short time and that low-concentration citric acid suffices.

In FIG. 13, citric acid cleaning comprises opening a valve 112 at first, filling a priming inlet 113 with water, closing the valve 112, introducing several g of citric acid into the water, stopping the operation of the apparatus, stopping the circulation, confirming the circulation stop, closing valves 114 and 115, then opening valves 112 and 116 to operate the apparatus for about 10 min and then stop the operation. Thereafter, a tube 117 entering the priming inlet 113 is dropped onto the drain outlet to discharge the citric acid liquid.

### EXAMPLE

Use of the water treatment apparatus according to the present invention can reduce the count of general viable bacteria to allow vegetables or fruits to enjoy a long life-span. The counts of general viable bacteria and E. Coli occurring in the root of green onion were measured in comparison between the presence and absence of the present invention apparatus. As a result, according to the standard plate cultivation method, results (1) in comparative examples revealed 1,100/g and 12,000/g, whereas results (2) revealed 300 or less/g and 2,700/g. Thus, the count of the general viable bacteria was reduced more in the presence of the present invention apparatus. It was verified, in view of the conventionally known fact that reduction of general viable bacterial has allowed vegetables or fruits to enjoy a long life-span, the utilization of the present invention apparatus enabled the count of general viable bacterial to be reduced.

TABLE 1

| | Sterilization and | | | Sterilization and | |
|---|---|---|---|---|---|
| | purification apparatus | | | purification apparatus | |
| Item | Presence | Absence | Item | Presence | Absence |
| Length | 58 | 55 | Thickness | 1 | 0.7 |
| | 54 | 47 | | 0.8 | 0.9 |
| | 55 | 50 | | 1.2 | 0.9 |
| | 62 | 47 | | 0.8 | 0.7 |
| | 64 | 50 | | 0.9 | 0.7 |
| | 61 | 47 | | 1 | 0.7 |
| | 62 | 49.5 | | 0.9 | 0.7 |
| | 61 | 47 | | 0.8 | 0.8 |
| | 58 | 50 | | 0.8 | 0.7 |
| | 63 | 57 | | 0.8 | 0.8 |
| Average | 59.80 | 49.95 | Average | 0.90 | 0.76 |
| | 100.0 | 83.5% | | 100.0 | 84.4% |

Table 1 includes green onion growth comparison data, from which it is understand that the green onions have different lengths and thicknesses between the presence and absence of the water treatment apparatus (sterilization and purification apparatus), that in either case, the facts of the presence exhibit the larger values and that the growth promotion effect can be confirmed. The reasons for the above are the following facts:
(1) Since oxygen is also dissolved in water simultaneously when ozone is dissolved in water, the oxygen concentration of the solution increases. Plants have their roots activated in the presence of the oxygen to increase the absorbency power of the nutrient contents.
(2) Plants absorb inorganic substances (nitrogen, phosphoric acid, potassium, etc.). Generally, the inorganic substances exist in organic substances. The organic substances are purified to take out the inorganic substances and, as a result, more inorganic substances can be absorbed.
(3) Fungi and bacteria producing the growth prevention factor are sterilized to enable an environment difficult to be affected by a disease to be established.
(4) Though a great amount of ozone constitutes a growth prevention factor, since the sterilization and purification apparatus of the present invention decomposes unnecessary ozone make excessive ozone treatment unnecessary and the apparatus compact in size. Therefore, the growth promotion effects can be obtained through rapid and continuous utilization of the sterilization and purification.

The water treatment apparatus for sterilization and purification purposes according to the present invention is applied not only to the nutriculture system, but also to hot springs, bathhouses, pools, for example, and can widely utilized as other water treatment apparatus.

### EXPLANATION OF REFERENCE NUMERALS

20 System main body

21 Culture solution

22 Nutrient solution tank

23 Culture bed

27 Effluent tank

30 Water treatment apparatus

43 Ozonizer

44 Reaction vessel

102 Branched flow passage

1. A nutriculture system for circulating a culture solution that is a liquid fertilizer between a nutrient solution tank containing the culture solution and culture beds, the nutriculture system comprising a water treatment apparatus disposed between the nutrient solution tank and the culture beds for sterilizing and purifying only a culture solution having flowed through the culture beds, wherein the water treatment apparatus comprises a unit having an ozone supply function for supplying ozone to the culture solution, an ultraviolet ray irradiation function for irradiating the culture solution with ultraviolet rays, and a photocatalyst-acting function for allowing a photocatalyst to act.

2. A nutriculture system according to claim 1, further comprising an effluent tank disposed on an upstream side of the nutrient solution tank for containing the culture solution having flowed through the culture beds and a sterilization and purification unit connected to the effluent tank.

3. A nutriculture system according to claim 2, wherein the sterilization and purification unit is provided with a branched flow passage for supplying directly to the effluent tank the culture solution having been sterilized and purified with the sterilization and purification unit.

4. A water treatment apparatus for sterilization and purification purposes, comprising a discharge ozonizer, a separate reaction vessel having an ultraviolet lamp embedded therein, and an air separator with an air vent valve with which ozone water having ozone produced with the ozonizer mixed with treated water is effluent-ozone degassed to form treatment ozone water that is supplied the reaction vessel.

5. A water treatment apparatus for sterilization and purification purposes according to claim 4, wherein the reaction vessel has a flow passage provided therein with a photocatalyst.

6. A water treatment apparatus for sterilization and purification purposes according to claim 4, wherein the air vent valve of the air separator has a degassing port provided with a cleaning rod operable from outward.

7. A water treatment apparatus for sterilization and purification purposes according to claim 5, wherein the air vent valve of the air separator has a degassing port provided with a cleaning rod operable from outward.
